(19) United States
(12) Patent Application Publication
(10) Pub. No.: US 2020/0033173 A1
(43) Pub. Date: Jan. 30, 2020

(54) AIR FLOW RATE MEASURING DEVICE

(71) Applicant: DENSO CORPORATION, Kariya-city (JP)

(72) Inventor: Noboru KITAHARA, Kariya-city (JP)

(21) Appl. No.: 16/592,942

(22) Filed: Oct. 4, 2019

Related U.S. Application Data
(63) Continuation of application No. PCT/JP2018/009852, filed on Mar. 14, 2018.

(30) Foreign Application Priority Data
Apr. 14, 2017 (JP) 2017-080778

(51) Int. Cl. G01F 1/72; F02D 41/18; G01F 1/696

(52) U.S. Cl. CPC G01F 1/72; G01F 1/696; F02D 41/187

(57) ABSTRACT

An air flow rate measuring device for a vehicle measures an air flow rate based on an output value of a sensing unit disposed under an environment in which an air flows. The air flow rate measuring device includes a processor programmed to calculate a standard deviation from sampling data in the output value for at least one cycle of a pulsation waveform of the air, calculate a kurtosis of the pulsation waveform from the output value, estimate the pulsation error that is correlated with the standard deviation and the kurtosis, and correct the air flow rate to mitigate the pulsation error by using the pulsation error.

### CROSS REFERENCE TO RELATED APPLICATIONS

This application is a continuation application of international Patent Application No. PCT/JP2018/009852 filed on Mar. 14, 2018, which designated the U.S. and claims the benefit of priority from Japanese Patent Application No. 2017-080778 filed on Apr. 14, 2017. The entire disclosure of all of the above applications are incorporated herein by reference.

### TECHNICAL FIELD

The present disclosure relates to an air flow rate measuring device.

### BACKGROUND ART

Conventionally, as an example of an air flow rate measuring device, there is a control device for an internal combustion engine. Such a control device calculates a pulsation amplitude ratio and a pulsation frequency, and calculates a pulsation error based on the pulsation amplitude ratio and the pulsation frequency. Then, the control device obtains a correction coefficient necessary for correcting a pulsation error by referring to a pulsation error correction map based on the pulsation amplitude ratio and the pulsation frequency, and calculates an air amount obtained by correcting the pulsation error.

### SUMMARY

A first aspect of the present disclosure is an air flow rate measuring device for a vehicle that measures an air flow rate based on an output value of a sensing unit disposed under an environment in which an air flows. The air flow rate measuring device includes a processor programmed to: calculate a standard deviation from sampling data in the output value for at least one cycle of a pulsation waveform of the air; calculate a kurtosis of the pulsation waveform from the output value; estimate the pulsation error that is correlated with the standard deviation and the kurtosis; and correct the air flow rate to mitigate the pulsation error by using the pulsation error.

A second aspect of the present disclosure is an air flow rate measuring device for a vehicle that measures an air flow rate based on an output value of a sensing unit disposed under an environment in which an air flows. The air flow rate measuring device includes a processor programmed to: calculate a standard deviation from sampling data in the output value for at least one cycle of a pulsation waveform of the air; calculate a skewness of the pulsation waveform from the output value; estimate the pulsation error that is correlated with the standard deviation and the skewness; and correct the air flow rate to mitigate the pulsation error by using the pulsation error.

A third aspect of the present disclosure is an air flow rate measuring device for a vehicle that measures an air flow rate based on an output value of a sensing unit disposed under an environment in which an air flows. The air flow rate measuring device includes a processor programmed to: calculate a standard deviation from sampling data in the output value for at least one cycle of a pulsation waveform of the air; acquire a pulsation frequency from the sampling data that is a frequency of the pulsation waveform; estimate a pulsation error of the air flow rate correlated with the standard deviation and the pulsation frequency; and correct the air flow rate to mitigate the pulsation error by using the pulsation error.

### BRIEF DESCRIPTION OF DRAWINGS

The above and other objects, features and advantages of the present disclosure will become more apparent from the following detailed description made with reference to the accompanying drawings.

FIG. 1 is a block diagram showing a schematic configuration of an AFM according to a first embodiment,

FIG. 2 is a block diagram showing a schematic configuration of a processing unit in the first embodiment,

FIG. 3 is a waveform diagram illustrating a method of determining a measurement period in the first embodiment,

FIG. 4 is a waveform diagram illustrating that an average value, a maximum value, and a minimum value are the same and a standard deviation is different,

FIG. 5 is a block diagram showing a schematic configuration of a processing unit according to a second embodiment,

FIG. 6 is a block diagram showing a schematic configuration of a processing unit in a modification of the second embodiment,

FIG. 7 is a block diagram showing a schematic configuration of a processing unit according to a third embodiment,

FIG. 8 is a block diagram showing a schematic configuration of a processing unit according to a fourth embodiment,

FIG. 9 is a diagram showing a two-dimensional map in the fourth embodiment,

FIG. 10 is a diagram showing a standard deviation to a pulsation error according to the fourth embodiment,

FIG. 11 is a block diagram showing a schematic configuration of a processing unit according to a fifth embodiment,

FIG. 12 is a block diagram showing a schematic configuration of a processing unit according to a sixth embodiment,

FIG. 13 is a block diagram showing a schematic configuration of a processing unit according to a seventh embodiment, and

FIG. 14 is a block diagram showing a schematic configuration of an AFM according to an eighth embodiment.

### DESCRIPTION OF EMBODIMENTS

An air flow rate measuring device obtains a correction coefficient necessary for correcting a pulsation error by referring to a pulsation error correction map based on the pulsation amplitude ratio and the pulsation frequency, and calculates an air amount obtained by correcting the pulsation error. However, in the intake pulsation, not only the sine wave but also the tendency of the pulsation error changes due to the deformation of the waveform (including the higher order component). In other words, in the intake pulsation, even if the pulsation amplitude ratio and the pulsation frequency are the same, the tendency of the pulsation error changes.

Furthermore, such a control device acquires a correction coefficient necessary for correcting the pulsation error from the pulsation amplitude ratio and the pulsation frequency, and calculates the air amount obtained by correcting the pulsation error with the use of the correction coefficient. For that reason, the control device cannot cope with the change in the pulsation error in the case where the pulsation waveform is deformed, and a correction accuracy may be deteriorated.

In view of the above, a plurality of embodiments for carrying out the present disclosure will be described with reference to the drawings. In each embodiment, portions corresponding to those described in the preceding embodiment are denoted by the same reference numerals, and redundant descriptions will be omitted in some cases. In each mode, when only a part of the configuration is described, the other parts of the configuration can be applied with reference to the other modes described above.

### First Embodiment

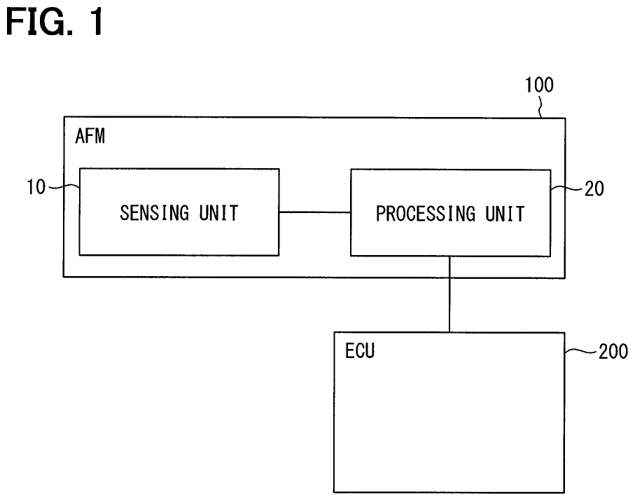

An air flow rate measuring device according to a first embodiment will be described with reference to FIGS. 1 to 4. In the present embodiment, as shown in FIG. 1, an air flow rate measuring device is applied to an AFM (air flow meter) 100. In other words, the AFM 100 corresponds to an air flow rate measuring device.

The AFM 100 is mounted, for example, on a vehicle equipped with an internal combustion engine (hereinafter, referred to as an engine). The AFM 100 has a thermal air flow rate measuring function for measuring a flow rate of an intake air (hereinafter, air flow rate) taken into a cylinder of the engine. Therefore, the AFM 100 can be regarded as a hot wire-type air flow meter. The air flow rate can also be referred to as an intake air flow rate.

The AFM 100 mainly includes a sensing unit 10 and a processing unit 20 or a processor. The AFM 100 is electrically connected to an ECU (Electronic Control Unit) 200. The ECU 200 corresponds to an internal combustion engine control device, and is an engine control device having a function of controlling the engine based on a detection signal from the AFM 100 and the like. The detection signal is an electric signal indicating the air flow rate corrected by a pulsation error correction unit 39.

The sensing unit 10 is disposed in an intake duct such as an outlet of an air cleaner or an intake pipe, for example, as an environment in which an air flows. For example, as disclosed in JP 2016-109625 A and the like, the sensing unit 10 is disposed in the intake duct in a state of being attached to a passage formation member. In other words, the sensing unit 10 is disposed in a sub-bypass passage by being attached to a passage formation member provided with a bypass passage (sub-air passage) and a sub-bypass passage (secondary sub-air passage) through which a part of the intake air flowing in an interior (main air passage) of the intake duct passes. However, the present disclosure is not limited to the above configuration, and the sensing unit 10 may be directly disposed in the main air passage.

The sensing unit 10 includes a heat generating resistive element, a temperature measuring resistive element, and the like. The sensing unit 10 outputs a sensor signal (output value, output flow rate) corresponding to the air flow rate flowing through the sub-bypass flow channel to the processing unit 20. It can also be conceived that the sensing unit 10 outputs an output value, which is an electric signal corresponding to the air flow rate flowing through the sub-bypass flow channel, to the processing unit 20.

In the intake duct, intake pulsations including backflow are generated due to a reciprocating motion of a piston in the engine or the like. In the sensing unit 10, an error of a true air flow rate occurs in the output value due to an influence of the intake pulsation. In particular, when a throttle valve is operated to a fully open side, the sensing unit 10 is susceptible to the influence of the intake pulsation. Furthermore, the intake pulsation changes the tendency of the error not only by the sine wave but also by the deformation of the waveform (including higher order components). Hereinafter, the error caused by the intake pulsation will also be referred to as a pulsation error Err. The true air flow rate is an air flow rate which is not affected by the intake pulsation.

The processing unit 20 measures the air flow rate based on the output value of the sensing unit 10, and outputs the measured air flow rate to the ECU 200. The processing unit 20 includes at least one calculation processing device (CPU), and a storage device for storing a program and data. For example, the processing unit 20 is realized by a microprocessor having a storage device readable by a computer. The processing unit 20 performs various calculations with the execution of programs stored in the storage medium by the calculation processing device, measures the air flow rate, and outputs the measured air flow rate to the ECU 200.

The storage device is a non-transitory tangible storage medium for non-transitory storage of computer readable programs and data. The storage medium is realized by a semiconductor memory, a magnetic disk, or the like. The storage device can also be referred to as a storage medium. The processing unit 20 may include a volatile memory for temporarily storing data.

The processing unit 20 has a function of correcting the output value in which the pulsation error Err occurs. In other words, the processing unit 20 corrects the air flow rate at which the pulsation error Err occurs so as to obtain a real air flow rate. Therefore, the processing unit 20 outputs to the ECU 200 the air flow rate obtained by correcting the pulsation error Err as the detection signal. It can also be conceivable that the processing unit 20 outputs an electric signal indicating the air flow rate to the ECU 200.

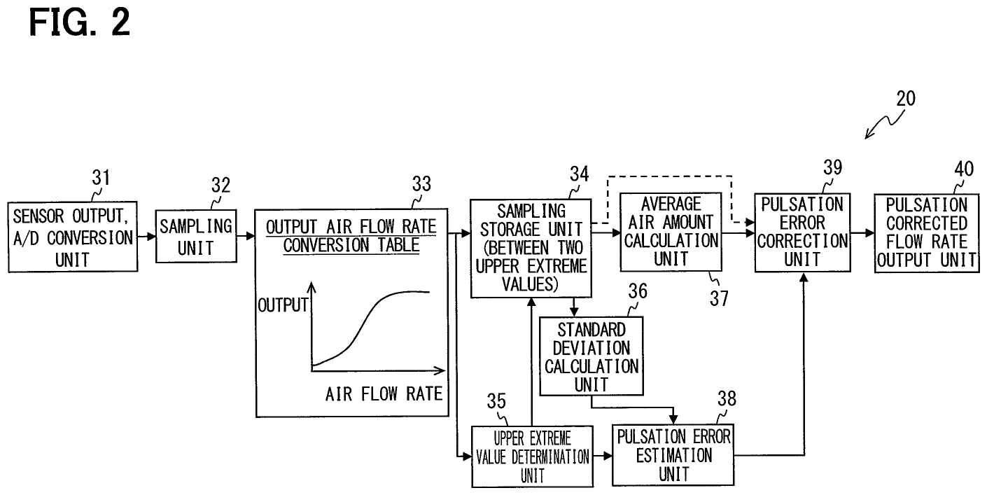

The processing unit 20 operates as multiple functional blocks by executing the program. In other words, the processing unit 20 has multiple functional blocks. As shown in FIG. 2, the processing unit 20 includes multiple functional blocks 31 to 40. The processing unit 20 includes, as functional blocks, a sensor output A/D conversion unit 31, a sampling unit 32, and an output air flow rate conversion table 33. The processing unit 20 performs A/D conversion on the output value output from the sensing unit 10 by the sensor output A/D conversion unit 31. Then, the processing unit 20 samples the A/D converted output value by the sampling unit 32, and converts the output value into an air flow rate by the output air flow rate conversion table 33.

The processing unit 20 further includes, as functional blocks, a sampling storage unit 34, an upper extreme value determination unit 35, a standard deviation calculation unit 36, an average air amount calculation unit 37, a pulsation error estimation unit 38, a pulsation error correction unit 39, and a pulsation corrected flow rate output unit 40.

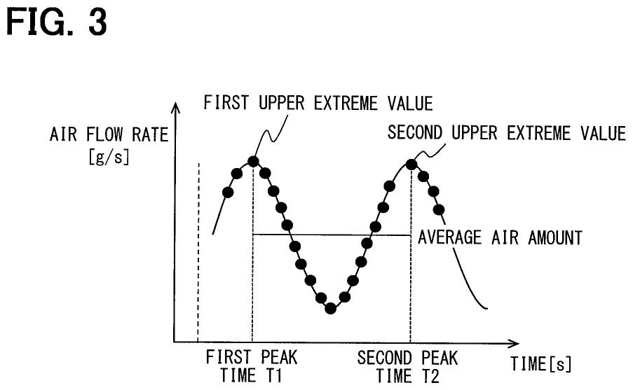

The sampling storage unit 34 stores multiple sampling values between the two upper extreme values determined by the upper extreme value determination unit 35. For example, as shown in FIG. 3, the upper extreme value determination unit 35 determines, as a first upper extreme value, a first sampling value at which the air flow rate corresponding to the sampling value is switched from an increase to a decrease among the multiple sampling values. Then, the upper extreme value determination unit 35 determines a sampling value at which the air flow rate corresponding to the next sampling value is switched from an increase to a decrease among the multiple sampling values as a second upper extreme value. In other words, the upper extreme value determination unit 35 determines the sampling value at a first peak time T1 as the first upper extreme value, and determines the sampling value at a second peak time T2, which is the next peak time, as the second upper extreme value. A waveform of the air flow rate between the first and second upper extreme values can be considered as one cycle of the pulsation waveform. For the purpose of preventing erroneous detection of the upper extreme value, a detection accuracy can be improved with the use of an appropriate low-pass filter. The pulsation waveform can also be referred to as a waveform of the air flow rate when the air pulsates.

The sampling storage unit 34 stores a sampling value between the first upper extreme value and the second upper extreme value. In other words, the sampling storage unit 34 includes sampling data for at least one cycle of the pulsation waveform. The sampling data for one cycle can be regarded as the multiple sampling values between the first upper extreme value and the second upper extreme value.

This is because a measurement period (calculation period) of an average air amount Gave and a standard deviation a is determined, and the average air amount Gave and the standard deviation a are calculated in the measurement period. In this example, the measurement period is provided between the first upper extreme value and the second upper extreme value. As the number of samplings is larger, the average air amount Gave and the standard deviation a can be calculated more accurately. The average air amount Gave is an average value of the air flow rates in a predetermined period. On the other hand, the standard deviation a is a value representing the degree of variation in the pulsating waveform with respect to the average air amount Gave, and the standard deviation a is a value representing the degree of variation in the pulsation waveforms with respect to the average air amount Gave. In addition, the standard deviation a can be considered to be a value representing the degree of variation of the sampling data with respect to the average air amount Gave of the sampling value.

In the present embodiment, as an example, the measurement period is set between the first upper extreme value and the second upper extreme value. However, the present disclosure is not limited to the above example. The processing unit 20 may calculate the pulsation cycle using the air flow rate converted by the output air flow rate conversion table 33, and may use the obtained pulsation cycle (one cycle) as the measurement period. In that case, the processing unit 20 includes a functional block for calculating the pulsation cycle and a function block for determining the measurement period instead of the sampling storage unit 34 and the upper extreme value determination unit 35.

The standard deviation calculation unit 36 calculates the standard deviation a from the sampling data for at least one cycle of the air pulsation in the output value. In other words, the standard deviation calculation unit 36 calculates (acquires) the standard deviation a of the air flow rate using the multiple sampling values stored in the sampling storage unit 34 and Expressions 1 and 2. The AFM 100 acquires the standard deviation a by the standard deviation calculation unit 36 in order to obtain the pulsation error Err for correcting the pulsation.

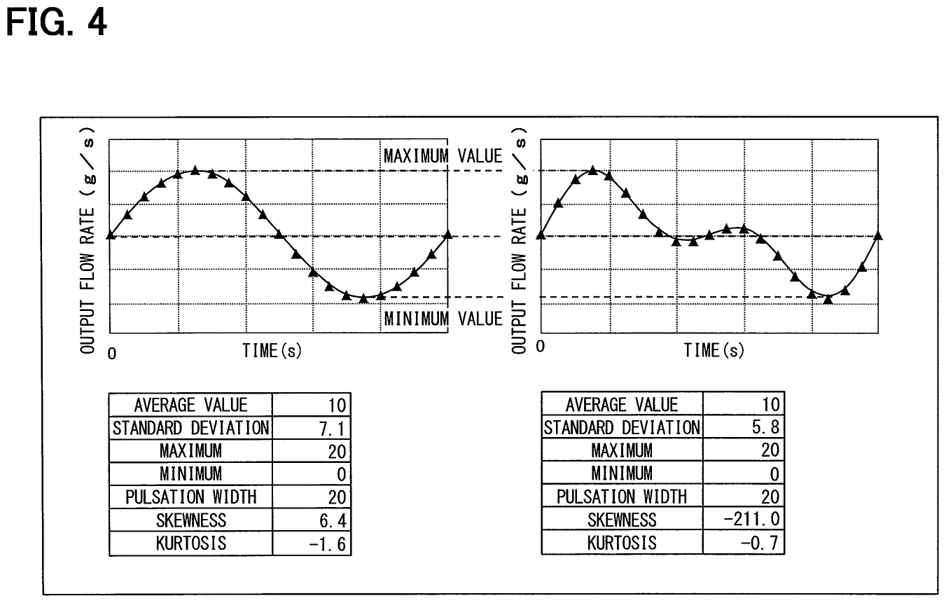

As shown in FIG. 4, the waveform of the air flow rate may have different waveforms even if the maximum value, the minimum value, and the average value of the output flow rate in the sensing unit 10 are the same. Since the pulsation error Err is also different in such different waveforms, there is a need to change a correction amount Q.

The standard deviation a can make a difference of the waveforms using all the information on the sampling points (triangle points) in FIG. 4. In other words, the standard deviation a can be considered to be a parameter that can express a difference of waveforms when the waveforms are different even if the maximum value, the minimum value, and the average value are the same. Therefore, the processing unit 20 can perform an optimal error correction by estimating the pulsation error Err using the standard deviation a. Further, the processing unit 20 can be considered to calculate the standard deviation a by the standard deviation calculation unit 36 in order to grasp the pulsation waveform by a statistical amount and perform a high-precision pulsation correction.

$$\begin{matrix}σ = \sqrt{{σ}^{2}} & [ Expression 1 ] \\ {σ}^{2} = \frac{1}{n} {\sum }_{i = 1}^{n} {( {x}_{i} - x ave )}^{2} & [ Expression 2 ]\end{matrix}$$

xᵢ: sampling value, xᵢ to xₙ: population, n: number of samplings (number of data), xave: average value of population

The average air amount calculation unit 37 calculates an average value of the air flow rate from the multiple sampling values stored in the sampling storage unit 34. In other words, the average air amount calculation unit 37 calculates the average air amount Gave of the air flow rate in the measurement period according to the output value of the sensing unit 10.

The average air amount calculation unit 37 calculates the average air amount Gave with the use of, for example, an integrated average. In this example, the calculation of the average air amount Gave will be described with reference to waveforms shown in FIG. 3. In this example, it is assumed that a period from the first peak time T1 to the second peak time T2 is a measurement period, the air flow rate of the first peak time T1 is G(1), and the air flow rate of the second peak time T2 is G(n). Then, the average air amount calculation unit 37 calculates the average air amount Gave with the use of Expression 3. In that case, as compared with a case in which the number of samples is small, when the number of samplings is large, the average air amount calculation unit 37 can calculate the average air amount Gave in which the effect of the pulsation minimum value whose detection accuracy is relatively lower is reduced.

$$Average Air Amount \text{:} Gave = \frac{{\sum }_{1}^{n} G ( t )}{n} \qquad [ Expression 3 ]$$

The average air amount calculation unit 37 may calculate the average air amount Gave by averaging the pulsation minimum value, which is the minimum value of the air flow rate, and the pulsation maximum value, which is the maximum value, during the measurement period. In other words, the average air amount calculation unit 37 calculates the average air amount Gave with the use of Expression 4.

$$Average Air Amount \text{:} Gave = \frac{( \begin{matrix}Pulsation maximum value + \\ Pulsation minimum value\end{matrix} )}{2} \qquad [ Expression 4 ]$$

The pulsation maximum value is a sampling value having the largest air flow rate among the multiple sampling values stored in the sampling storage unit 34. On the contrary, the pulsation minimum value is a sampling value having the smallest air flow rate among the multiple sampling values stored in the sampling storage unit 34.

The average air amount calculation unit 37 may calculate the average air amount Gave without using a pulsation minimum value whose detection accuracy is lower than the maximum value of the air flow rate, or several air amounts of the pulsation minimum value and before and after the pulsation minimum value. The processing unit 20 corrects the air flow rate so that the pulsation error Err becomes small with respect to the average air amount Gave. Therefore, the processing unit 20 can measure the air flow rate in which the effect of the pulsation minimum value is reduced by allowing the average air amount calculation unit 37 to calculate the average air amount Gave without using the pulsation minimum value.

The pulsation error estimation unit 38 estimates the pulsation error Err of the air flow rate correlated with the standard deviation a. The pulsation error estimation unit 38 estimates the pulsation error Err of the air flow rate correlated with the standard deviation σ by using, for example, a map in which the standard deviation σ and the pulsation error Err are associated with each other. In other words, when the standard deviation σ is obtained by the standard deviation calculation unit 36, the pulsation error estimation unit 38 extracts the pulsation error Err correlated with the obtained standard deviation σ from the map. It can also be conceived that the pulsation error estimation unit 38 acquires the pulsation error Err correlated with the standard deviation a.

In that instance, the AFM 100 includes a map in which the multiple standard deviations σ and the pulsation errors Err correlated with the respective standard deviations σ are associated with each other. Further, the map can be created by confirming a relationship between each standard deviation σ and the pulsation error Err correlated with each standard deviation σ by an experiment or a simulation using an actual machine. In other words, each pulsation error Err can be conceived to be a value obtained for each standard deviation σ when the experiment or a simulation using the actual machine is performed while the value of the standard deviation σ is changed. It should be noted that the map in the embodiment to be described below can be similarly created by the experiment or the simulation using the actual machine, or the like.

As described above, the AFM 100 is disposed in the intake duct with the sensing unit 10 attached to the passage formation member. Therefore, the AFM 100 may not only increase the pulsation error Err as the standard deviation σ increases, but also may decrease the pulsation error Err as the standard deviation σ increases due to the effect of a shape of the passage formation member or the like. For that reason, in the AFM 100, a relationship between the standard deviation σ and the pulsation error Err cannot be expressed by a function in some cases. Therefore, the AFM 100 is preferable because an accurate pulsation error Err can be estimated by using the map as described above. In the map, the multiple standard deviations σ and the correction amounts Q correlated with the respective standard deviations σ may be associated with each other.

However, the AFM 100 may be able to express the relationship between the standard deviation σ and the pulsation error Err by a function when the sensing unit 10 is directly disposed in the main air passage. In that instance, the AFM 100 may calculate the pulsation error Err using the above function. Since the AFM 100 has no need to have the map by calculating the pulsation error Err using the function, the storage device can be reduced in capacitance. This also applies to the following embodiments. In other words, in the following embodiments, the pulsation error Err may be obtained by using a function instead of the map.

The pulsation error Err is a value obtained by estimating a difference between the uncorrected air flow rate obtained by the output value and the true air flow rate. In other words, it can be considered that the pulsation error Err corresponds to a difference between the air flow rate whose output value is converted by the output air flow rate conversion table 33 and the true air flow rate. Further, the pulsation error Err can be considered to be an estimated value or a theoretical value of the error. Therefore, the correction amount Q for bringing the air amount before correction closer to the true air flow rate can be obtained if the pulsation error Err is known.

The pulsation error correction unit 39 corrects the air flow rate so that the pulsation error Err is mitigated by using the pulsation error Err estimated by the pulsation error estimation unit 38. In other words, the pulsation error correction unit 39 corrects the air flow rate so that the air flow rate affected by the intake pulsation approaches the true air flow rate. In this example, the average air amount Gave is adopted as a target to be corrected for the air flow rate.

For example, the pulsation error correction unit 39 obtains the correction amount Q based on the estimated pulsation error Err by using a calculation, a map in which the multiple pulsation errors Err and the correction amounts Q correlated with the respective pulsation errors Err are associated with each other, or the like. Then, for example, the pulsation error correction unit 39 can correct the air flow rate so that the pulsation error Err is reduced by adding the correction amount Q to the average air amount Gave.

In other words, when the correction amount Q is minus Q1, the pulsation error correction unit 39 adds minus Q1 to the average air amount Gave, that is, subtracts Q1 from the average air amount Gave, thereby obtaining the corrected air flow rate in which the pulsation error Err is mitigated. When the correction amount Q is positive Q2, the pulsation error correction unit 39 adds Q2 to the average air amount Gave, thereby obtaining a corrected air flow rate in which the pulsation error Err is mitigated. However, the present disclosure is not limited to the above example, and can be adopted as long as the air flow rate can be corrected so that the pulsation error Err becomes small.

In the present embodiment, the air flow rate is corrected so that the pulsation error Err is reduced for the average air amount Gave. However, the present disclosure is not limited to the above example. As indicated by a dashed line in FIG. 2, the pulsation error correction unit 39 may correct the air flow rate so that the pulsation error Err is reduced for a value before the calculation by the average air amount calculation unit 37.

The pulsation corrected flow rate output unit 40 outputs the air flow rate corrected by the pulsation error correction unit 39. In the present embodiment, the pulsation corrected flow rate output unit 40 that outputs the air flow rate corrected by the pulsation error correction unit 39 to the ECU 200 is employed.

In this manner, the AFM 100 calculates the standard deviation σ from the sampling data for at least one cycle of the pulsation waveforms. As a result, when the maximum value, the minimum value, and the average value of the output of the sensing unit 10 are the same but the waveforms are different from each other, the AFM 100 can grasp the degree of variation of the respective waveforms. Since the AFM 100 estimates the pulsation error Err correlated with the standard deviation a, the pulsation error Err suitable for each of the waveforms as described above can be obtained.

Since the AFM 100 corrects the air flow rate so as to mitigate the pulsation error Err using the pulsation error Err estimated in this manner, even when the waveforms are different as described above, the air flow rate can be corrected so as to mitigate the pulsation error Err corresponding to the respective waveforms. In other words, the AFM 100 can improve the accuracy of correcting the air flow rate.

In the present embodiment, the AFM 100 including the sensing unit 10 in addition to the processing unit 20 is employed. However, the present disclosure measures the air flow rate based on the output value of the sensing unit 10, and may include the processing unit 20 including the standard deviation calculation unit 36, the pulsation error estimation unit 38, and the pulsation error correction unit 39.

The preferred embodiment of the present disclosure has been described above. However, the present disclosure is not limited in any way to the above-mentioned embodiment, and various modifications can be performed without departing from the spirit of the present disclosure. Hereinafter, second to eighth embodiments will be described as other modes of the present disclosure. The above embodiment and the second embodiment to the eighth embodiment can be implemented independently, or can be implemented in combination as appropriate. The present disclosure is not limited to the combinations shown in the embodiments, but can be implemented by various combinations.

The functions realized by the processing unit 20 may be realized by hardware and software different from those described above, or a combination of the hardware and the software. The processing unit 20 may communicate with, for example, another control device, such as an ECU 200, and the other control device may perform some or all of the processing. The processing unit 20 can be implemented by a digital circuit or an analog circuit, including a large number of logic circuits, when the processing unit 20 is implemented by an electronic circuit.

### Second Embodiment

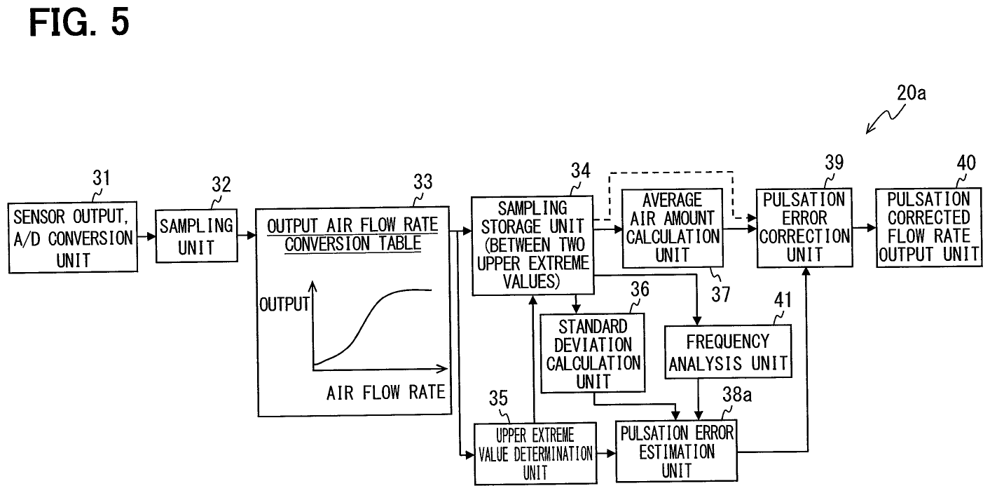

An AFM according to a second embodiment (hereinafter referred to simply as AFM) will be described with reference to FIG. 5. The AFM is different from the AFM 100 in a part of the processing unit 20a. As shown in FIG. 5, the AFM includes a frequency analysis unit 41, and the AFM is different from the AFM 100 in that a pulsation frequency F obtained by the frequency analysis unit 41 is input to a pulsation error estimation unit 38a. In other words, the processing unit 20a includes a frequency analysis unit 41 in addition to the processing unit 20.

The pulsation error estimation unit 38a estimates a pulsation error Err using a standard deviation σ and a pulsation frequency F. In other words, the pulsation error estimation unit 38a estimates the pulsation error Err also correlated with the pulsation frequency F in addition to the standard deviation σ. The frequency analysis unit 41 corresponds to a frequency acquisition unit. The pulsation frequency F is a frequency of a pulsation waveform in air, and can also be referred to as a frequency of the air flow rate. In addition, the pulsation frequency F can be corrected with higher accuracy by analyzing not only the first order waves but also the higher order frequencies such as the second order waves and the third order waves.

The frequency analysis unit 41 calculates the pulsation frequency F according to the multiple sampling values stored in a sampling storage unit 34. The frequency analysis unit 41 calculates the pulsation frequency F based on, for example, an interval between two peaks of the pulsation waveform. A time of a first peak is referred to as a first peak time T1, and a time of a second peak is referred to as a second peak time T2. In this case, the pulsation frequency F[Hz]=1/(T2−T1). Therefore, the frequency analysis unit 41 can obtain the pulsation frequency F by calculating 1/(T2−T1).

The frequency analysis unit 41 may calculate the pulsation frequency F based on a time spanning a threshold. The first time that crosses the threshold is set as a first crossing time T11, and the second time that crosses the threshold is set as a second crossing time T12. In that case, the pulsation frequency F[Hz]=1/(T12−T11). Therefore, the frequency analysis unit 41 can obtain the pulsation frequency F by calculating 1/(T12−T11). Further, the frequency analysis unit 41 may calculate the pulsation frequency F by Fourier-transform.

The pulsation error estimation unit 38a estimates the pulsation error Err correlated with the pulsation frequency F and the standard deviation σ with the use of, for example, a map in which the pulsation error Err is associated with the pulsation frequency F and the standard deviation σ. In other words, when the pulsation frequency F is obtained by the frequency analysis unit 41 and the standard deviation σ is obtained by the standard deviation calculation unit 36, the pulsation error estimation unit 38a extracts the pulsation error Err correlated with the obtained pulsation frequency F and the obtained standard deviation σ from the map.

In that case, the AFM includes a two-dimensional map in which multiple combinations of the pulsation frequency F and the standard deviation σ and the pulsation error Err correlated with each combination are associated with each other. In the two-dimensional map, for example, pulsation frequencies F1 to Fn are taken on one axis and standard deviations σ1 to an are taken on the other axis, and pulsation errors Err1 to Errn are associated with respective combinations of the pulsation frequencies F and the standard deviations σ. For example, the pulsation error Err1 is associated with the pulsation frequency F1 and the standard deviation al. The pulsation error Errn is associated with the pulsation frequency Fn and the standard deviation an. Each of the pulsation errors Err1 to Errn can be considered to be a value obtained by each of combinations of the pulsation frequency F and the standard deviation σ when the experiment and the simulation using the actual machine are performed by changing the values of the pulsation frequency F and the standard deviation σ.

The AFM of the present embodiment configured as described above can exhibit the same effects as those of the AFM 100. Furthermore, the pulsation error Err is also influenced by the pulsation frequency F. For that reason, according to the present embodiment, since the pulsation error Err correlated with the standard deviation σ and the pulsation frequency F is estimated and corrected using the pulsation error Err, the correction with higher accuracy than that in the case of correction using only the pulsation error Err correlated with the standard deviation σ can be performed.

(Modification)

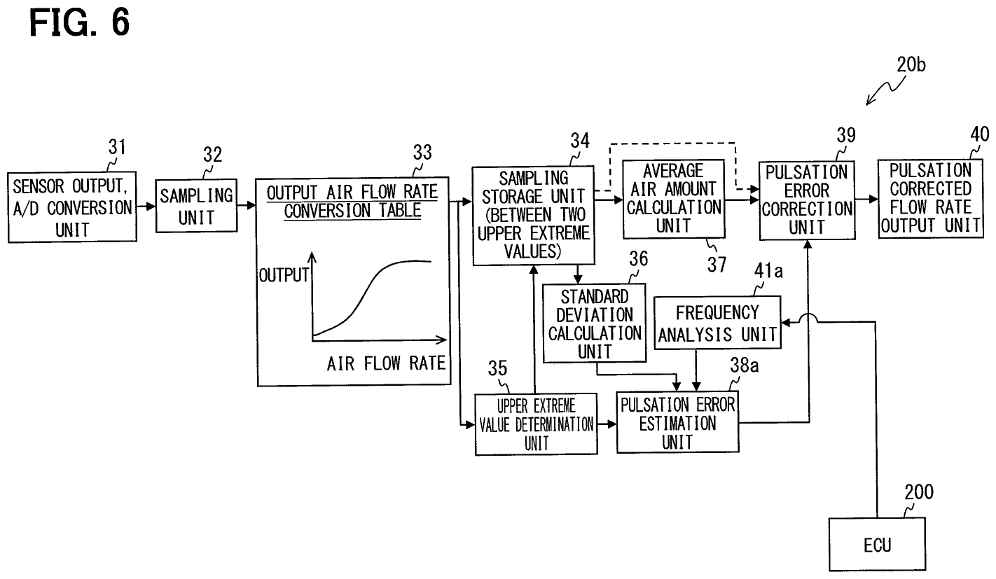

Hereinafter, an AFM of a modification in the second embodiment (hereinafter referred to simply as AFM) will be described with reference to FIG. 6. In the AFM, a part of the processing unit 20b is different from that of the second embodiment. As shown in FIG. 6, the processing unit 20b is different from the processing unit 20a in that the frequency analysis unit 41a acquires a pulsation frequency based on a signal from the ECU 200.

The frequency analysis unit 41a acquires, for example, a signal indicating a rotational speed of an engine output shaft (that is, engine rotation speed), a sensor signal of a crank angle sensor, and the like from the ECU 200 as information indicating an operating condition of the engine. Then, the frequency analysis unit 41a calculates the pulsation frequency based on the signal acquired from the ECU 200. In that case, the frequency analysis unit 41a may acquire the pulsation frequency F with the use of, for example, a map in which the engine rotation speed and the pulsation frequency F are associated with each other. The frequency analysis unit 41a may calculate the pulsation frequency by employing, as the signals acquired from the ECU 200, the engine speed, the throttle opening degree, a VCT opening, and the like, which are information indicating the operating condition of the engine. The VCT is a registered trademark.

The AFM of the modification can exhibit the same effects as those of the second embodiment. Further, since the AFM according to the modification acquires the pulsation frequency based on the information from the ECU 200, the processing load in the AFM can be reduced as compared with the case where the pulsation frequency is calculated according to the multiple sampling values stored in the sampling storage unit 34.

### Third Embodiment

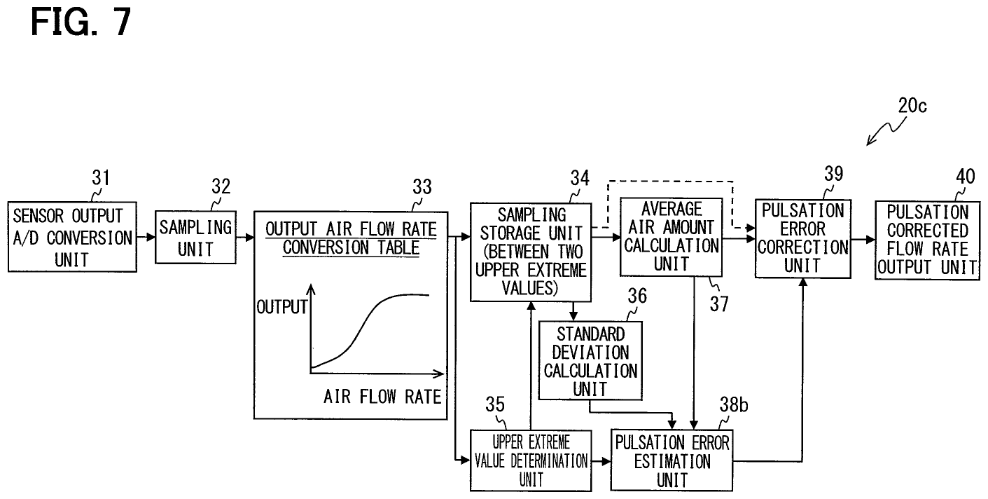

An AFM according to a third embodiment (hereinafter referred to simply as AFM) will be described with reference to FIG. 7. The AFM is different from the AFM 100 in a part of a processing unit 20c. As shown in FIG. 7, the AFM is different from the AFM 100 in that an average air amount Gave obtained by an average air amount calculation unit 37 is input to a pulsation error estimation unit 38b.

The pulsation error estimation unit 38b estimates a pulsation error Err using the average air amount Gave and a standard deviation σ. In other words, the pulsation error estimation unit 38b estimates a pulsation error Err also correlated with the average air amount Gave in addition to the standard deviation σ.

In that instance, the pulsation error estimation unit 38b estimates the pulsation error Err correlated with the average air amount Gave and the standard deviation σ using, for example, a map in which the pulsation error Err is associated with the average air amount Gave and the standard deviation σ. In other words, when the average air amount Gave is obtained by the average air amount calculation unit 37 and the standard deviation σ is obtained by the standard deviation calculation unit 36, the pulsation error estimation unit 38b extracts the pulsation error Err correlated with the obtained average air amount Gave and the obtained standard deviation σ from the map.

In that instance, the AFM includes a two-dimensional map in which multiple combinations of the multiple average air amounts Gave and the multiple standard deviations σ are associated with the pulsation errors Err correlated with the respective combinations. In the two-dimensional map, for example, the average air amounts Gave1 to Gaven are taken on one axis and the standard deviations σ1 to an are taken on the other axis, and the pulsation errors Err1 to Errn are associated with the respective combinations of the average air amounts Gave1 to Gaven and the standard deviations σ1 to an. For example, the pulsation error Err1 is associated with the average air amount Gave1 and the standard deviation al. The average air amount Gaven and the standard deviation an are associated with the pulsation error Errn. Each of the pulsation errors Err1 to Errn can be considered to be a value obtained by each of combinations of the standard deviation σ and the average air amount Gave when an experiments and a simulation using an actual machine are performed by changing the values of the standard deviation σ and the average air amount Gave.

The AFM of the present embodiment configured as described above can exhibit the same effects as those of the AFM 100. Furthermore, the pulsation error Err is also influenced by the average air amount Gave. For that reason, in the present embodiment, since the pulsation error Err correlated with the standard deviation σ and the average air amount Gave is estimated and corrected with the use of the pulsation error Err, the correction with higher accuracy can be performed than that when the correction is performed with the use of only the pulsation error Err correlated with the standard deviation σ.

### Fourth Embodiment

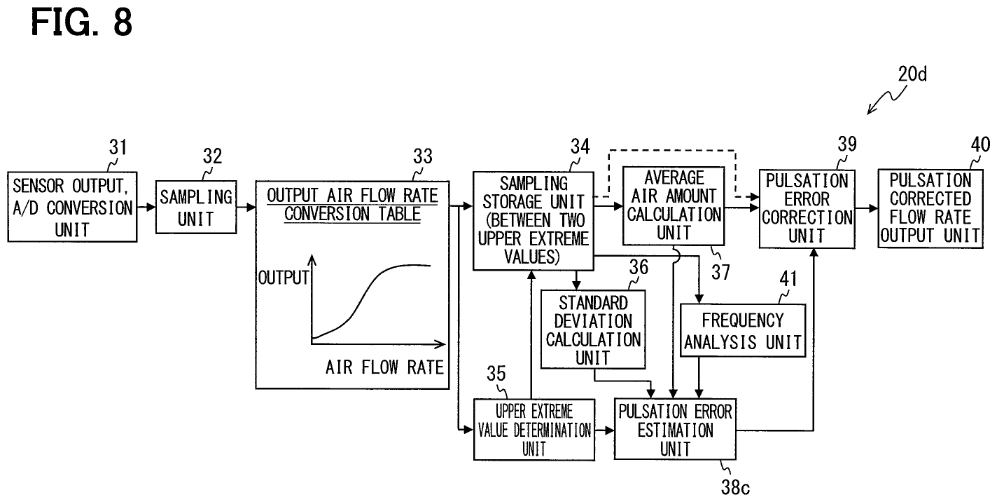

An AFM according to a fourth embodiment (hereinafter referred to simply as AFM) will be described with reference to FIGS. 8, 9, and 10. In the AFM, a part of the processing unit 20d is different from that of the AFM 100. As shown in FIG. 8, the AFM is different from the AFM 100 in that an average air amount Gave obtained by an average air amount calculation unit 37 and a pulsation frequency F obtained by a frequency analysis unit 41 are input to a pulsation error estimation unit 38c.

In other words, the processing unit 20d includes a frequency analysis unit 41 similarly to the processing unit 20a, and the pulsation frequency F obtained by the frequency analysis unit 41 is input to the pulsation error estimation unit 38c. Similarly to the processing unit 20c, the processing unit 20d inputs the average air amount Gave obtained by the average air amount calculation unit 37 to the pulsation error estimation unit 38c. The processing unit 20d may include a frequency analysis unit 41a instead of the frequency analysis unit 41.

The pulsation error estimation unit 38c estimates a pulsation error Err with the use of the pulsation frequency F, the average air amount Gave, and the standard deviation σ. In other words, the pulsation error estimation unit 38c estimates the pulsation error Err further correlated with the pulsation frequency F and the average air amount Gave in addition to the standard deviation σ. Therefore, the fourth embodiment can be regarded as an embodiment in which the first embodiment, the second embodiment, and the third embodiment are combined together.

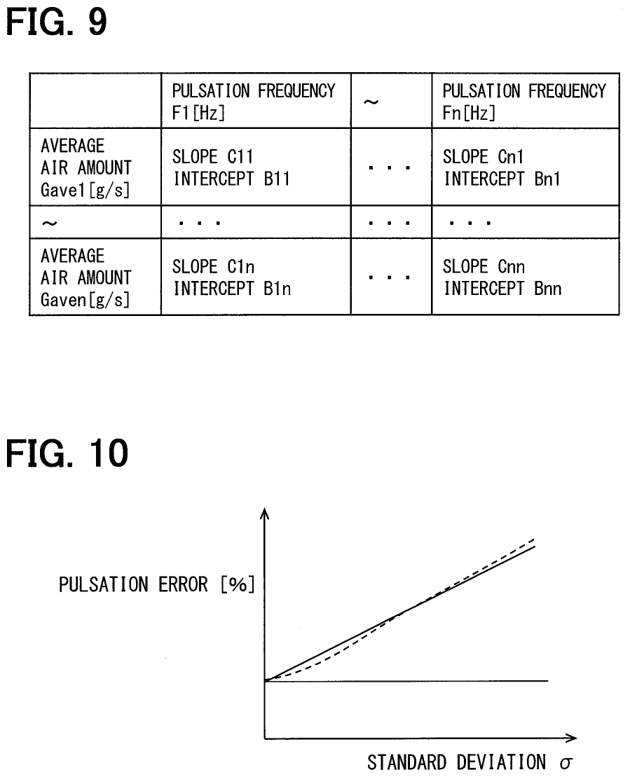

In that instance, the pulsation error estimation unit 38c estimates the pulsation error Err correlated with the pulsation frequency F, the average air amount Gave, and the standard deviation σ with the use of, for example, a two-dimensional map shown in FIG. 9 and an error estimation expression to be described below. In other words, the AFM has the two-dimensional map shown in FIG. 9. The error estimation expression can be expressed by pulsation error Err=Cnn X A+Bnn. In the error estimation expression, Cnn is a slope and Bnn is an intercept.

A relationship between the pulsation error Err [%] and the standard deviation σ is different for each combination of the multiple pulsation frequencies F and the multiple standard deviations σ. In other words, the slope and intercept of FIG. 10 are different for each combination of the multiple pulsation frequencies F and the multiple standard deviations σ. A solid line in FIG. 10 indicates a relationship between the pulsation error Err after correction and the standard deviation σ. On the other hand, a dashed line indicates a relationship between the pulsation error Err before correction and the standard deviation σ, that is, a pulsation characteristic.

In the map, as shown in FIG. 9, a combination of the slope Cnn and the intercept Bnn correlated with respective combinations of the average air amount rate Gave and the pulsation frequency F is associated with each other. More specifically, in the two-dimensional map, for example, the average air amounts Gave1 to Gaven is taken on one axis and the pulsation frequencies F1 to Fn are taken on the other axis, and the respective combinations of the average air amounts Gave1 to Gaven and the pulsation frequencies F1 to Fn are associated with the respective combinations of the slope Cnn and the intercept Bnn. Each of the slope Cnn and the intercept Bnn can be obtained by an experiment or a simulation using an actual machine.

It can be considered that the map is used to acquire the slope Cnn and the intercept Bnn when calculating the pulsation error Err. In other words, in the map, the coefficients in the error estimation expression are associated with each average air amount Gave and each standard deviation σ.

The pulsation error estimation unit 38c acquires the slope C11 and the intercept B11 with the use of the map, for example, when the standard deviation al, the pulsation frequency F1, and the average air amount Gave 1 are used. The pulsation error estimation unit 38c can obtain the pulsation error Err by calculating C11 X standard deviation σ1+B11 using the error estimation expression.

The AFM of the present embodiment configured as described above can exhibit the same effects as those of the AFM 100. Further, in the present embodiment, since the pulsation error Err correlated with the standard deviation σ, the average air amount Gave, and the pulsation frequency F is estimated and corrected with the use of the pulsation error Err, the correction with higher accuracy than that when correction is performed using only the pulsation error Err correlated with the standard deviation σ can be performed.

### Fifth Embodiment

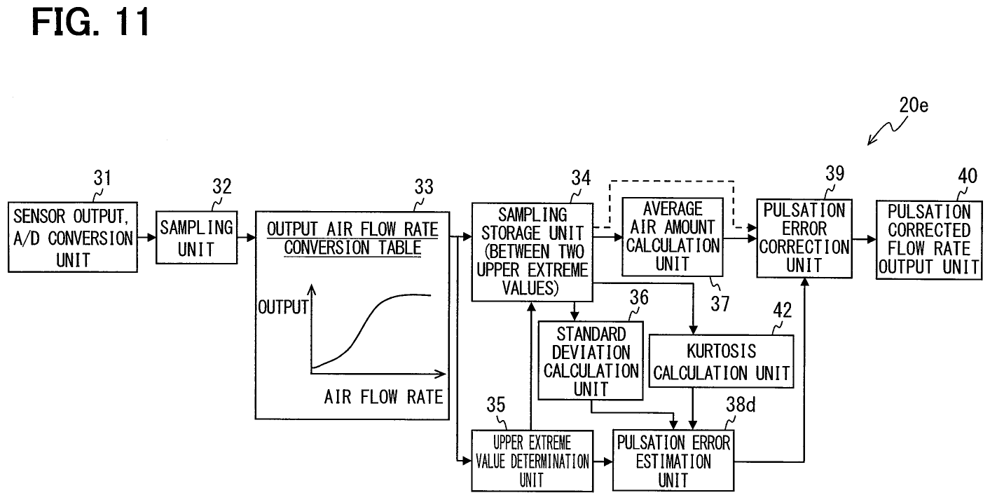

An AFM according to a fifth embodiment (hereinafter referred to simply as AFM) will be described with reference to FIG. 11. In the AFM, a part of a processing unit 20e is different from that of the AFM 100. As shown in FIG. 11, the AFM includes a kurtosis calculation unit 42, and the AFM is different from the AFM 100 in that a kurtosis Ku obtained by the kurtosis calculation unit 42 is input to a pulsation error estimation unit 38d. In other words, the processing unit 20e includes the kurtosis calculation unit 42 in addition to the processing unit 20.

The pulsation error estimation unit 38d estimates the pulsation error Err with the use of the standard deviation σ and the kurtosis Ku. That is, the pulsation error estimation unit 38a estimates a pulsation error Err also correlated with the kurtosis Ku in addition to the standard deviation σ.

The kurtosis calculation unit 42 calculates the kurtosis Ku according to the multiple sampling values stored in a sampling storage unit 34. For example, the kurtosis calculation unit 42 calculates the kurtosis Ku with the use of Expression 5.

$$Ku = \frac{\frac{1}{n} {\sum }_{i = 1}^{n} {( {x}_{i} - xave )}^{4}}{{σ}^{4}} \qquad [ Expression 5 ]$$

The kurtosis Ku is an index indicating whether a shape of the distribution is pointed or flattened. In other words, the kurtosis Ku can be considered to be an index indicating whether the peaks and valleys of the pulsation waveform are pointed or flattened.

As described above, even if the maximum value, the minimum value, and the average value of the output flow rate in the sensing unit 10 are the same, the waveform of the air flow rate is different, that is, if the kurtosis Ku is different, the correction amount Q needs to be changed. The kurtosis Ku can make a difference in waveform by using, for example, all the information of the sampling points (triangle points) in FIG. 4. In other word, the kurtosis Ku can be considered to be a parameter that can express a difference of the waveforms when the waveforms are different even if the maximum value, the minimum value, and the average value are the same. Therefore, the processing unit 20e can perform an optimal error correction by estimating the pulsation error Err with the use of the kurtosis Ku in addition to the standard deviation σ. Further, the processing unit 20e can be considered to calculate the kurtosis Ku by the kurtosis calculation unit 42 in order to grasp the pulsation waveform by statistical quantities and perform high-precision pulsation correction.

The pulsation error estimation unit 38d estimates the pulsation error Err correlated with the kurtosis Ku and the standard deviation σ with the use of, for example, a map in which the pulsation error Err is associated with the kurtosis Ku and the standard deviation σ. In other words, when the kurtosis Ku is obtained by the kurtosis calculation unit 42 and the standard deviation σ is obtained by the standard deviation calculation unit 36, the pulsation error estimation unit 38d extracts the pulsation error Err correlated with the obtained kurtosis Ku and the obtained standard deviation σ from the map.

In that case, the AFM includes a two-dimensional map in which multiple combinations of the kurtosis Ku and the standard deviation σ are associated with the pulsation error Err correlated with each combination. In the two-dimensional map, for example, the kurtosis Ku1 to Kun are taken on one axis, the standard deviations σ1 to an are taken on the other axis, and the pulsation errors Err1 to Errn are associated with each of the combinations of the kurtosis Ku and the standard deviation σ. For example, the pulsation error Err1 is associated with the kurtosis Ku1 and the standard deviation σ1. The pulsation error Errn is associated with the kurtosis Kun and the standard deviation an. Each of the pulsation errors Err1 to Errn can be considered to be a value obtained by combining the kurtosis Ku and the standard deviation σ when an experiment or a simulation using an actual machine is performed by changing the values of the kurtosis Ku and the standard deviation σ.

The AFM of the present embodiment configured as described above can exhibit the same effects as those of the AFM 100. Furthermore, the pulsation error Err is also influenced by the kurtosis Ku. For that reason, in the present embodiment, since the pulsation error Err correlated with the standard deviation σ and the kurtosis Ku is estimated and corrected with the use of the pulsation error Err, the correction with higher accuracy can be performed than that when the correction is performed by using only the pulsation error Err correlated with the standard deviation σ.

### Sixth Embodiment

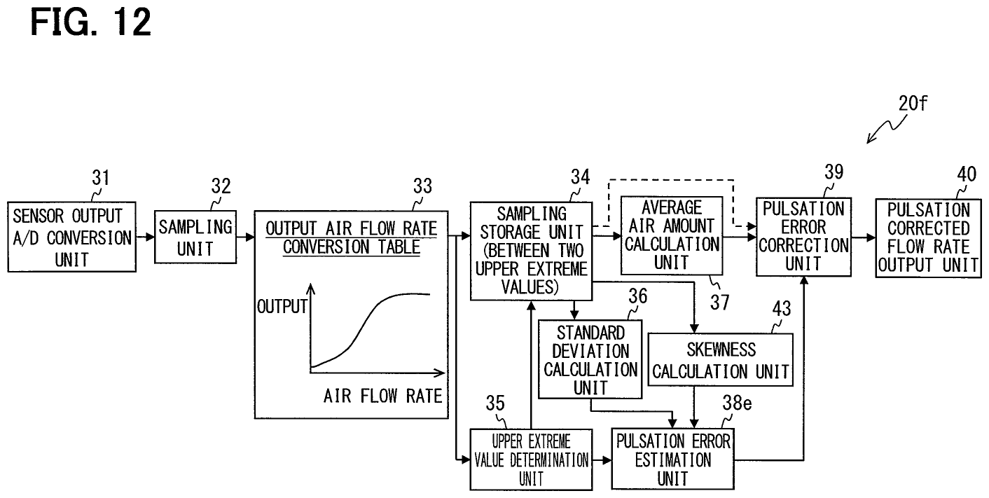

An AFM according to a sixth embodiment (hereinafter referred to simply as AFM) will be described with reference to FIG. 12. In the AFM, a part of the processing unit 20f is different from that in the AFM 100. As illustrated in FIG. 12, the AFM includes a skewness calculation unit 43, and is different from the AFM 100 in that a skewness Sk obtained by a skewness calculation unit 43 is input to a pulsation error estimation unit 38e. In other words, the processing unit 20f includes the skewness calculation unit 43 in addition to the processing unit 20.

The pulsation error estimation unit 38e estimates the pulsation error Err with the use of the standard deviation σ and the skewness Sk. In other words, the pulsation error estimation unit 38e estimates the pulsation error Err correlated with the skewness Sk in addition to the standard deviation σ.

The skewness calculation unit 43 calculates the skewness Sk according to multiple sampling values stored in a sampling storage unit 34. It can also be considered that the skewness calculation unit 43 acquires the skewness of the pulsation waveform. For example, the skewness calculation unit 43 calculates the skewness Sk using Expression 6.

$$Sk = \frac{\frac{1}{n} {\sum }_{i = 1}^{n} {( {x}_{i} - xave )}^{3}}{{σ}^{3}} \qquad [ Expression 6 ]$$

The skewness Sk is an index representing asymmetry of data. In other words, the skewness Sk can be considered to be an index representing the asymmetry of the pulsation waveform.

As described above, even if the maximum value, the minimum value, and the average value of the output flow rate in the sensing unit 10 are the same, if the waveform of the air flow rate is different, that is, the skewness Sk is different, there is a need to change the correction amount Q. The skewness Sk can make a difference in waveform with the use of, for example, all the information on the sampling points (triangle points) in FIG. 4. In other words, the skewness Sk can be considered to be a parameter that can express a difference of the waveforms when the waveforms are different even if the maximum value, the minimum value, and the average value are the same. Therefore, the processing unit 20f estimates the pulsation error Err with the use of the skewness Sk in addition to the standard deviation σ, thereby making it possible to perform an optimum error correction. Further, the processing unit 20f can be considered to calculate the skewness Sk by the skewness calculation unit 43 in order to grasp the pulsation waveform by statistical quantities and perform a high-precision pulsation correction.

The pulsation error estimation unit 38e estimates the pulsation error Err correlated with the skewness Sk and the standard deviation σ with the use of, for example, a map in which the pulsation error Err is associated with the skewness Sk and the standard deviation σ. In other words, when the skewness Sk is obtained by the skewness calculation unit 43 and the standard deviation σ is obtained by the standard deviation calculation unit 36, the pulsation error estimation unit 38d extracts the pulsation error Err correlated with the obtained skewness Sk and the obtained standard deviation σ from the map.

In that case, the AFM includes a two-dimensional map in which multiple combinations of the skewness Sk and the standard deviation σ are associated with the pulsation error Err correlated with each combination. In the two-dimensional map, for example, the skewness Sk1 to Skn are set on one axis, the standard deviations σ1 to an are set on the other axis, and the pulsation errors Err1 to Errn are associated with each of the combinations of the skewness Sk and the standard deviation σ. For example, the pulsation error Err1 is associated with the skewness Sk1 and the standard deviation σ1. The pulsation error Errn is associated with the skewness Skn and the standard deviation an. In other words, each of the pulsation errors Err1 to Errn can be considered to be a value obtained by combining the kurtosis Ku and the standard deviation σ when an experiment or a simulation using an actual machine are performed while changing the values of the skewness Sk and the standard deviation σ.

The AFM of the present embodiment configured as described above can exhibit the same effects as those of the AFM 100. Furthermore, the pulsation error Err is also affected by the skewness Sk. For that reason, according to the present embodiment, since the pulsation error Err correlated with the standard deviation σ and the skewness Sk is estimated and corrected with the use of the pulsation error Err, the correction with higher accuracy can be performed than that in the case where correction is performed using only the pulsation error Err correlated with the standard deviation σ.

### Seventh Embodiment

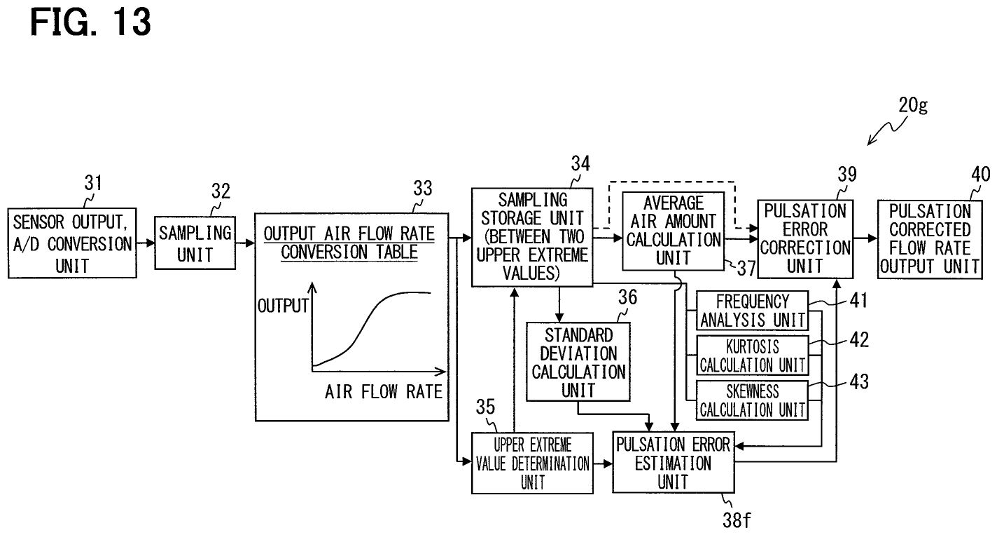

An AFM according to a seventh embodiment (hereinafter referred to simply as AFM) will be described with reference to FIG. 13. In the AFM, a part of a processing unit 20g differs from that in the AFM 100. The AFM is different from the AFM in that the AFM includes a frequency analysis unit 41, a kurtosis calculation unit 42, and a skewness calculation unit 43, and the pulsation frequency F, the kurtosis Ku, and the skewness Sk obtained by the frequency analysis unit 41, the kurtosis calculation unit 42, and the skewness calculation unit 43, and the average air amount Gave obtained by the average air amount calculation unit 37 are input to the pulsation error estimation unit 38f in the AFM 100.

Like the processing unit 20d, the processing unit 20g includes a frequency analysis unit 41, and the pulsation frequency F obtained by the frequency analysis unit 41 and the average air amount Gave obtained by the average air amount calculation unit 37 are input to the pulsation error estimation unit 3f. In the processing unit 20g, similarly to the processing unit 20e and the processing unit 20f, the kurtosis Ku obtained by the kurtosis calculation unit 42 is input to the pulsation error estimation unit 38f, and the skewness Sk obtained by the skewness calculation unit 43 is input to the pulsation error estimation unit 38f. The processing unit 20g may include a frequency analysis unit 41a instead of the frequency analysis unit 41.

The pulsation error estimation unit 38f estimates the pulsation error Err with the use of the pulsation frequency F, the average air amount Gave, the kurtosis Ku, the skewness Sk, and the standard deviation σ. In other words, the pulsation error estimation unit 38f estimates the pulsation error Err correlated with the pulsation frequency F, the average air amount Gave, the kurtosis Ku, and the skewness Sk in addition to the standard deviation σ. Therefore, the seventh embodiment can be regarded as an embodiment in which the first embodiment, the second embodiment, the third embodiment, the fifth embodiment, and the sixth embodiment are combined together.

The AFM estimates the pulsation error Err correlated with the pulsation frequency F, the average air amount Gave, the kurtosis Ku, the skewness Sk, and the standard deviation σ with the use of, for example, a multi-dimensional map in which the two-dimensional map shown in FIG. 9 is provided for each combination of the multiple kurtosis Ku and the multiple skewness Sk, and the error estimation expression. In other words, in the multi-dimensional map, each combination of the kurtosis Ku and the skewness Sk is associated with a combination of the slope Cnn and the intercept Bnn correlated with each combination of the average air amount Gave and the pulsation frequency F. The AFM has such a multi-dimensional map. Each of the slope Cnn and the intercept Bnn in each two-dimensional map can be obtained by an experiment or a simulation using an actual machine.

The AFM of the present embodiment configured as described above can exhibit the same effects as those of the AFM 100. Furthermore, as described above, the pulsation error Err is affected not only by the standard deviation σ but also by the average air amount Gave, the pulsation frequency F, the kurtosis Ku, and the skewness Sk. For that reason, in the present embodiment, since the pulsation error Err correlated with the above parameters is estimated and corrected using the pulsation error Err, the correction with higher accuracy can be performed than that in the case where the correction is performed using only the pulsation error Err correlated with the standard deviation σ.

It should be noted that the present disclosure can achieve the object as long as the pulsation error Err is estimated by using at least the standard deviation σ. Therefore, the processing unit 20g may estimate the pulsation error Err without using the average air amount Gave. For example, the processing unit 20g may estimate the pulsation error Err correlated with the standard deviation σ, the pulsation frequency F, and the kurtosis Ku. The processing unit 20g may estimate the pulsation error Err correlated with the standard deviation σ, the pulsation frequency F, and the skewness Sk. The processing unit 20g may estimate the pulsation error Err correlated with the standard deviation σ, the pulsation frequency F, the kurtosis Ku, and the skewness Sk.

Further, the processing unit 20g may estimate the pulsation error Err without using the pulsation frequency F. For example, the processing unit 20g may estimate the pulsation error Err correlated with the standard deviation σ, the average air amount Gave, and the kurtosis Ku. The processing unit 20g may estimate the pulsation error Err correlated with the standard deviation σ, the average air amount Gave, and the skewness Sk. Further, the processing unit 20g may estimate the pulsation error Err correlated with the standard deviation σ, the average air amount Gave, the kurtosis Ku, and the skewness Sk.

### Eighth Embodiment

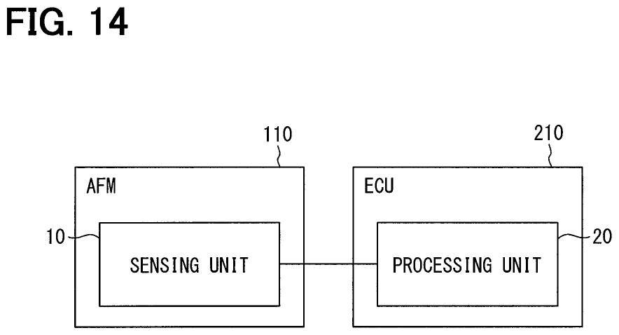

In this example, a modification of an eighth embodiment will be described with reference to FIG. 14. The eighth embodiment is different from the first embodiment in that a sensing unit 10 is provided on the AFM 110 and a processing unit 20 is provided on the ECU 210. In other words, in the present embodiment, the present disclosure is applied to the processing unit 20 provided in the ECU 210. The present disclosure (air flow rate measuring device) may include a sensing unit 10 in addition to the processing unit 20.

For that reason, the AFM 110 and the ECU 210 can exhibit the same effects as those of the AFM 100. Further, since the AFM 110 does not include the processing unit 20, a processing load can be reduced more than that of the AFM 100.

The eighth embodiment can also be applied to the second to seventh embodiments. In that instance, the processing units 20a to 20f in the respective embodiments are provided in the ECU 210. Therefore, the ECU 210 analyzes the pulsation frequency F, calculates the kurtosis Ku, and the like.

Although the present disclosure has been described in accordance with the embodiments, it is understood that the present disclosure is not limited to such embodiments or structures. The present disclosure encompasses various modifications and variations within the scope of equivalents. In addition, various combinations and configurations, as well as other combinations and configurations that include only one element, more, or less, fall within the scope and spirit of the present disclosure.

1. An air flow rate measuring device for a vehicle that measures an air flow rate based on an output value of a sensing unit disposed under an environment in which an air flows, the air flow rate measuring device comprising
a processor programmed to:
calculate a standard deviation from sampling data in the output value for at least one cycle of a pulsation waveform of the air;
calculate a kurtosis of the pulsation waveform from the output value;
estimate the pulsation error that is correlated with the standard deviation and the kurtosis; and
correct the air flow rate to mitigate the pulsation error by using the pulsation error.

2. An air flow rate measuring device for a vehicle that measures an air flow rate based on an output value of a sensing unit disposed under an environment in which an air flows, the air flow rate measuring device comprising
a processor programmed to:
calculate a standard deviation from sampling data in the output value for at least one cycle of a pulsation waveform of the air;
calculate a skewness of the pulsation waveform from the output value;
estimate the pulsation error that is correlated with the standard deviation and the skewness; and
correct the air flow rate to mitigate the pulsation error by using the pulsation error.

3. The air flow rate measuring device according to claim 1, wherein
the processor is further programmed to:
acquire a pulsation frequency that is a frequency of the pulsation waveform, and
estimate the pulsation error that is further correlated with the pulsation frequency.

4. An air flow rate measuring device for a vehicle that measures an air flow rate based on an output value of a sensing unit disposed under an environment in which an air flows, the air flow rate measuring device comprising
a processor programmed to:
calculate a standard deviation from sampling data in the output value for at least one cycle of a pulsation waveform of the air;
acquire a pulsation frequency from the sampling data that is a frequency of the pulsation waveform;
estimate a pulsation error of the air flow rate correlated with the standard deviation and the pulsation frequency; and
correct the air flow rate to mitigate the pulsation error by using the pulsation error.

5. The air flow rate measuring device according to claim 4, wherein
the processor is further programmed to:
calculate a kurtosis of the pulsation waveform from the output value; and
estimate the pulsation error that is further correlated with the kurtosis.

6. The air flow rate measuring device according to claim 4, wherein
the processor is further programmed to:
calculate a skewness of the pulsation waveform from the output value; and
estimate the pulsation error that is further correlated with the skewness.

7. The air flow rate measuring device according to claim 1, wherein
the processor is further programmed to:
calculate from the output value an average air amount that is an average value of the air flow rate; and
estimate the pulsation error that is further correlated with the average air amount.

8. The air flow rate measuring device according to claim 1, wherein
the processor is configured to communicate with an electronic control unit (ECU) that controls an internal combustion engine of the vehicle, and
the processor is further programmed to output the air flow rate corrected by using the pulsation error to the ECU to control the internal combustion engine using the air flow rate.
